(19) United States
(12) Patent Application Publication
(10) Pub. No.: US 2024/0359039 A1
(43) Pub. Date: Oct. 31, 2024

(54) METHOD FOR CLIMBING AND DESCENDING USING ASCENDER AND ASCENDER

(71) Applicant: KENTECH SYSTEMS CO., LTD., Kawagoe-shi (JP)

(72) Inventor: Kenji OGURA, Kawagoe-shi (JP)

(73) Assignee: KENTECH SYSTEMS CO., LTD., Kawagoe-shi (JP)

(21) Appl. No.: 18/541,197

(22) Filed: Dec. 15, 2023

(30) Foreign Application Priority Data
Apr. 30, 2023 (JP) 2023-075355

(51) Int. Cl. A62B 1/14; F16C 3/02

(52) U.S. Cl. CPC A62B 1/14; F16C 3/02

(57) ABSTRACT

A method for climbing and descending using an ascender including a differential reduction drive that includes an input shaft driven by a rotary power tool and an output shaft coupled to a pulley allowing a rope to be wound, reduces a forward rotational speed applied to the input shaft, and transmits the reduced forward rotational speed to the output shaft. The input shaft of the ascender is provided with a one-way clutch portion that allows a forward rotation and prevents a reverse rotation. The forward rotation of the pulley is performed by restricting rotation of the one-way clutch portion about the input shaft and driving the input shaft to rotate forward in a climbing direction by the rotary power tool. The reverse rotation of the pulley is performed by releasing the rotation restriction of the one-way clutch portion about the input shaft.

### CROSS-REFERENCE TO RELATED APPLICATIONS

This application is based on and claims priority under 35 USC 119 from Japanese Patent Application No. 2023-075355 filed on Apr. 30, 2023, the contents of which are incorporated herein by reference.

### TECHNICAL FIELD

The present disclosure relates to a method for climbing and descending using an ascender and an ascender, and more particularly, to a method for climbing and descending using power and an ascender.

### BACKGROUND ART

JP6507463B1 discloses an ascender that enables climbing using a portable rotary power tool such as a power screwdriver. The ascender is small and does not take up much space, and can be used in places without commercial power supply facilities.

When a driving of a rechargeable power screwdriver is stopped while a rope is being pulled, a large pulling force from an outlet side to an inlet side is applied to the rope due to a load applied to an ascender, and a large reverse rotational force is generated in a pulley, a reduction drive, an input shaft, and a drive shaft until a cam prevention unit operates to completely stop a movement of the rope. An internal structure of a rechargeable power screwdriver may be damaged by an excessive reverse rotational load applied to the drive shaft.

The present disclosure is made in view of the above-described problem in the related art, and an object of the present disclosure is to provide a method for climbing and descending using an ascender and an ascender, which can prevent a reverse rotational force from being transmitted to a rotary power tool and damaging the rotary power tool when operation of the rotary power tool is stopped during climbing.

### SUMMARY OF INVENTION

The present disclosure provides a method for climbing and descending using an ascender, the ascender including a differential reduction drive that includes an input shaft configured to be driven by a rotary power tool and an output shaft coupled to a pulley allowing a rope to be wound, reduces a forward rotational speed applied to the input shaft, and transmits the reduced forward rotational speed to the output shaft. The method includes driving the input shaft by the power tool and rotating the pulley forward, in a state in which one end side of the rope is located in a high position to ensure a fulcrum, the rope is wound from an inlet side to an outlet side of the pulley of the ascender, a weight of a user is supported by the ascender, and the rotary power tool is coupled to the input shaft, to move the rope from the inlet side to the outlet side of the pulley and to ascend the user, and rotating the pulley reversely to descend the user in a state in which the rotary power tool is detached from the input shaft. The input shaft of the ascender is provided with a one-way clutch portion that allows a forward rotation and prevents a reverse rotation. The forward rotation of the pulley is performed by restricting rotation of the one-way clutch portion about the input shaft and driving the input shaft to rotate forward in a climbing direction by the rotary power tool. The reverse rotation of the pulley is performed by releasing the rotation restriction of the one-way clutch portion about the input shaft and allowing the pulley and the reduction drive to rotate reversely by a tension generated in an inlet-side rope to which the weight of the user is applied.

The present disclosure provides an ascender including a differential reduction drive that includes an input shaft configured to be driven by a rotary power tool and an output shaft coupled to a pulley allowing a rope to be wound around, reduces a forward rotational speed of the input shaft, and transmits the reduced forward rotational speed to the output shaft, a one-way clutch portion detachably or undetachably attached to the input shaft, allowing forward rotation of the input shaft, and preventing reverse rotation, and a rotation restricting and releasing portion configured to restrict and release rotation of the one-way clutch portion about an axis of the input shaft.

According to the present disclosure, when the input shaft is driven to rotate forward by a rotary power tool in a state in which the one-way clutch portion attached to the input shaft is restricted from rotating about the input shaft, the one-way clutch portion does not restrict the rotation of the input shaft, a rotational force of the rotary power tool is transmitted to the input shaft, and the pulley rotates forward after deceleration by the reduction drive. As a result, the rope moves from the inlet side to the outlet side of the pulley, a body of a user is lifted together with the ascender, and climbing along the rope is possible.

When it is desired to stop climbing, the operation of the rotary power tool is stopped. A reverse rotational force is generated in the pulley, the reduction drive, and the input shaft by the tension generated in the inlet-side rope to which the weight of the user is applied. The one-way clutch portion intends to rotate about the input shaft in response to the reverse rotational force of the input shaft, but a one-way clutch function works since the rotation about the input shaft is restricted, and reverse rotation of the pulley, the reduction drive, and the input shaft is prevented. As a result, the reverse rotational force is not transmitted to the rotary power tool, and damage can be prevented.

When it is desired to descend, the rotary power tool is detached from the input shaft, and the rotation restriction of the one-way clutch portion about the input shaft is released. The one-way clutch portion rotates together with the input shaft by the reverse rotational force transmitted to the input shaft of the reduction drive through the pulley due to the tension generated in the inlet-side rope to which the weight of the user is applied. As a result, the one-way clutch function does not work, the reverse rotation of the input shaft is not prevented, the reverse rotation of the pulley and the reduction drive is possible, and the rope can be moved from the outlet side to the inlet side of the pulley and descending is possible.

### BRIEF DESCRIPTION OF DRAWINGS

FIG. 1 is an external perspective view illustrating an example of a rope traction device in the related art with a part omitted;

FIG. 2 is a front view of FIG. 1;

FIG. 3 is a front view of FIG. 1 with a part omitted;

FIG. 4 is a back view of FIG. 1;

FIG. 5 is a schematic view of a method for using FIG. 1;

FIG. 6 is a schematic view of operation of a prevention unit in FIG. 1;

FIG. 7 is a schematic view of operation of the prevention unit in FIG. 1;

FIG. 8A is a schematic view of a rechargeable power screwdriver that drives the rope traction device, FIG. 8B is a cross-sectional view taken along a line A-A in FIG. 8A;

FIG. 9A is a schematic view of a manual rotary tool that drives the rope traction device, FIG. 9B is a cross-sectional view taken along a line B-B in FIG. 9A;

FIG. 10 is a back view of a power ascender and illustrates principles of the present disclosure;

FIG. 11 is a side view of FIG. 10 with a part broken and omitted;

FIG. 12 is a front view of FIG. 10;

FIG. 13 is a schematic view of a method for using the ascender in FIG. 10;

FIG. 14 is a schematic view of a method for using the ascender in FIG. 10;

FIG. 15 is a schematic view of a method for using the ascender in FIG. 10;

FIG. 16 is a back view of an ascender according to a modification of FIG. 10;

FIG. 17 is a schematic view of a method for using a rotary power tool drive shaft when the rechargeable power screwdriver is switchable between forward and backward rotations;

FIG. 18 is a back view of an ascender according to another modification of the present disclosure;

FIG. 19 is a front view of a rotary power tool drive shaft according to an embodiment of the present disclosure;

FIG. 20 is a cross-sectional view of the rotary power tool drive shaft in FIG. 19;

FIGS. 21A, 21B, and 21C are assembly views of the rotary power tool drive shaft in FIG. 19; and

FIG. 22 is a schematic view illustrating a method for using the rotary power tool drive shaft in FIG. 19.

### DESCRIPTION OF EMBODIMENTS

Hereinafter, preferred embodiments of the present disclosure will be described with reference to the accompanying drawings.

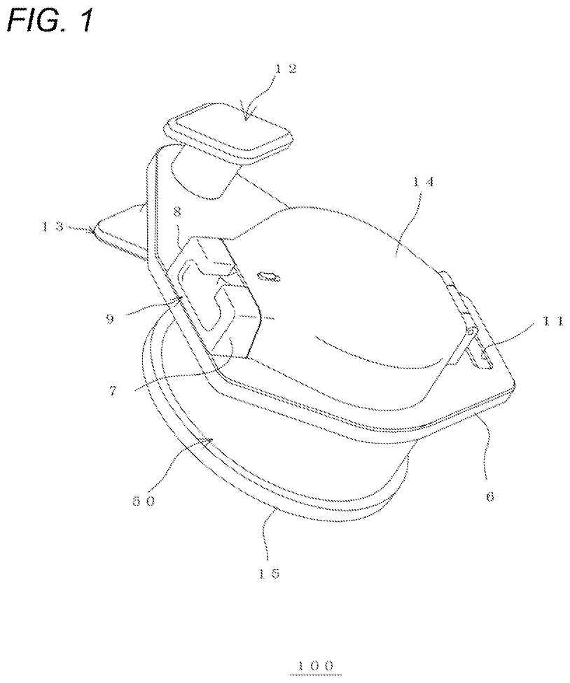

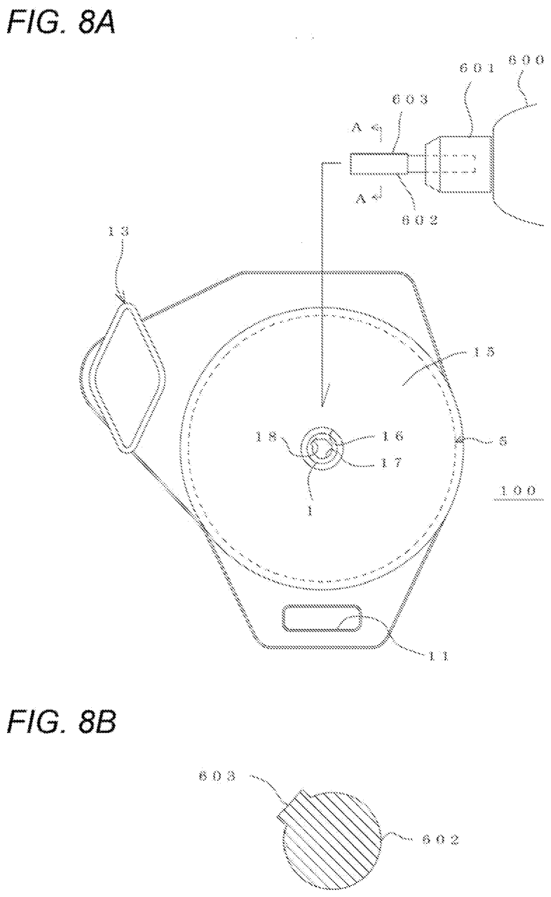

According to embodiments, an ascender 100 includes: a differential reduction drive that includes an input shaft 1 allowing a drive shaft 602 (driving tip tool, see FIG. 8A) attached to a chuck 601 of a rechargeable power screwdriver 600, which is an example of the rotary power tool, to be detachably coupled and an output shaft 4 coupled to a pulley 3 allowing a rope 2 to be detachably wound, reduces a rotational speed of the input shaft 1, and transmits the reduced rotational speed to the output shaft 4; a support body 6 attached to a front surface of the reduction drive 5; a rope inlet and outlet portion 9 that is provided on an upper end portion of a front surface of the support body 6 and includes an inlet portion 7 and an outlet portion 8 that constitute an inlet and an outlet of the rope 2 wound around the pulley 3 disposed on a front side of the support body 6; a cam prevention unit 300 that is provided on the front surface of the support body 6 and prevents an inlet side of the rope 2 from being drawn out to outside; an attachment hole 11 that is provided in a lower portion of the support body 6 and allows other ropes, carabiners, and the like to be attached; hook portions 12 and 13 that are provided on respective front and rear surfaces of an upper right portion of the support body 6 and allow an outlet side of the rope 2 to be wound and hooked; a pulley cover 14 that is pivoted at a lower portion of the front surface of the support body 6 and surrounds a front surface and a side surface of the pulley 3 in an openable and closable manner; and a sealing case 15 that is attached to a back surface of the support body 6 and covers a side surface and a back surface of the reduction drive 5. The reduction drive 5 and the sealing case constitute a reduction unit 50 (the prevention unit 300 is omitted in FIG. 1).

The sealing case 15 is formed with, in a center on a back surface thereof, an opening 16 through which the drive shaft 602 can be inserted and detached. The input shaft 1 is provided with a key groove 18 in a cylindrical shaft hole 17. As illustrated in FIGS. 8A and 8B, the columnar drive shaft 602 including a key portion 603 is attached to the chuck 601 of the rechargeable power screwdriver 600, and is inserted into the shaft hole 17 and coupled while the key portion 603 is fitted into the key groove 18. The input shaft 1 can be rotated by driving the rechargeable power screwdriver 600. The output shaft 4 protrudes from an opening (not illustrated) of the support body 6 to the front side, and the pulley 3 is coupled to an end portion of the output shaft 4.

The reduction drive 5 includes a differential speed reducer having a large speed reduction ratio due to a cycloidal speed reducer or a trochoidal speed reducer, and reduces the rotational speed of the input shaft 1 and transmits the reduced rotational speed to the output shaft 4. For example, the reduction drive 5 is of a type in which the input shaft 1 and the output shaft 4 rotate in opposite directions, and a direction in which the input shaft 1 rotates clockwise and the output shaft 4 rotates counterclockwise when viewed from a front side of a rope traction device is defined as a forward rotation direction. Examples of the reduction drive include a ball speed reducer or a pin cycloidal speed reducer that has coaxial input and output shafts.

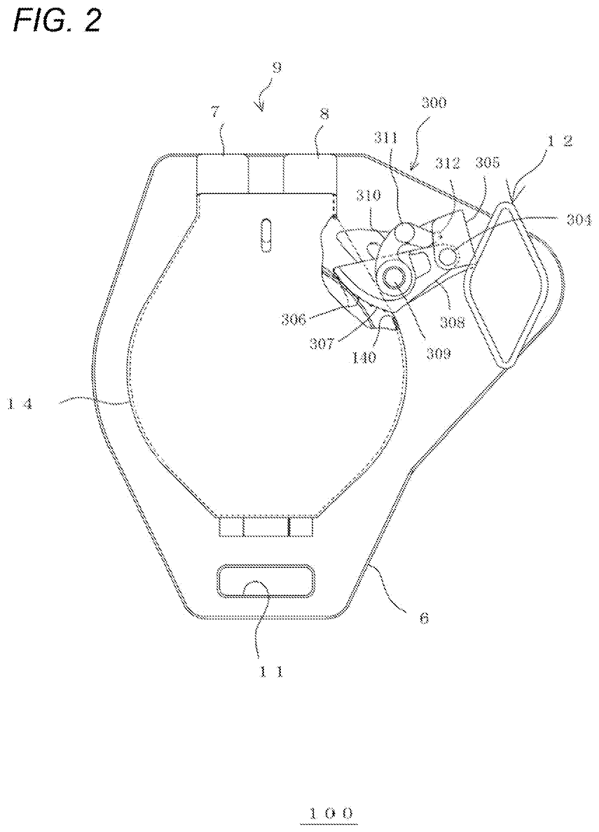

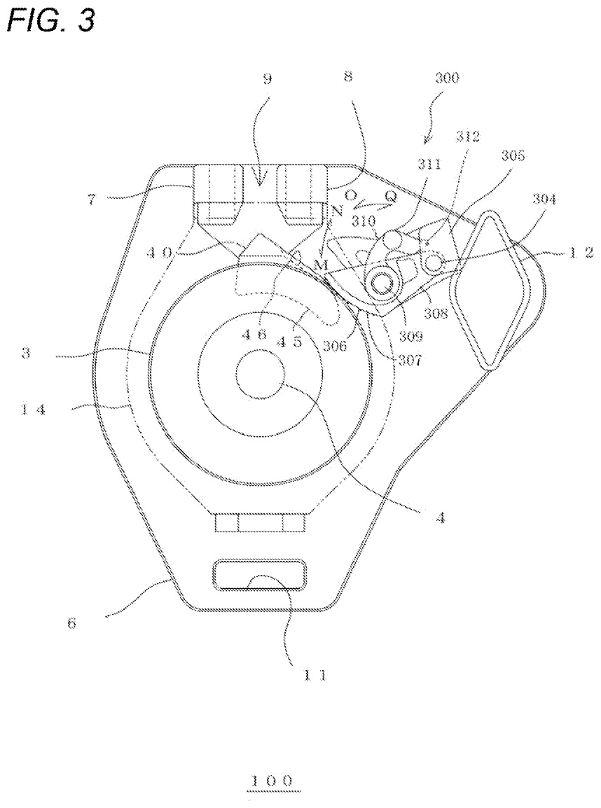

The cam prevention unit 300 is attached to an upper right portion of the front surface of the support body 6 among the outlet portion 8, the pulley 3, and the hook portion 12. In the prevention unit 300, a support plate 301 is attached to the upper right portion on the front surface of the support body 6, and a right portion of the prevention unit 300 is bent in a U-shape to form a bent portion 305 to which a pivot shaft 304 is attached in a rotatable 25 manner. To the pivot shaft 304 is fitted a base portion of a cam 308 having plural teeth 306 protruding from an outer peripheral portion 307. The cam 308 is pivotable about the pivot shaft 304 in a direction toward and away from a rope passed through a rope groove of a rope contact portion to be described later (see arrows M and N in FIG. 3). A spiral spring (not illustrated) that constantly biases the cam 308 counterclockwise in FIGS. 2 and 3 is interposed between the pivot shaft 304 and the cam 308.

To the cam 308, a pivot shaft 309 is rotatably attached in a vicinity of a center thereof, and to the pivot shaft 309 is fitted a base portion of an L-shaped releasing operation member 310. To a corner portion of the releasing operation member 310 is attached a columnar operation protrusion 311 protruding forward of the support body 6, and the releasing operation member 310 is pivotable about the pivot shaft 309 by operating the operation protrusion 311 with a finger (see arrows O and Q in FIG. 3). A tip side of the releasing operation member 310 is bent in a J-shape to form an engagement portion 312 that disengageably engages with an outer side of the bent portion 305 of the support plate 301. A spiral spring (not illustrated) that constantly biases the releasing operation member 310 clockwise in FIGS. 2 and 3 is interposed between the pivot shaft 309 and the releasing operation member 310.

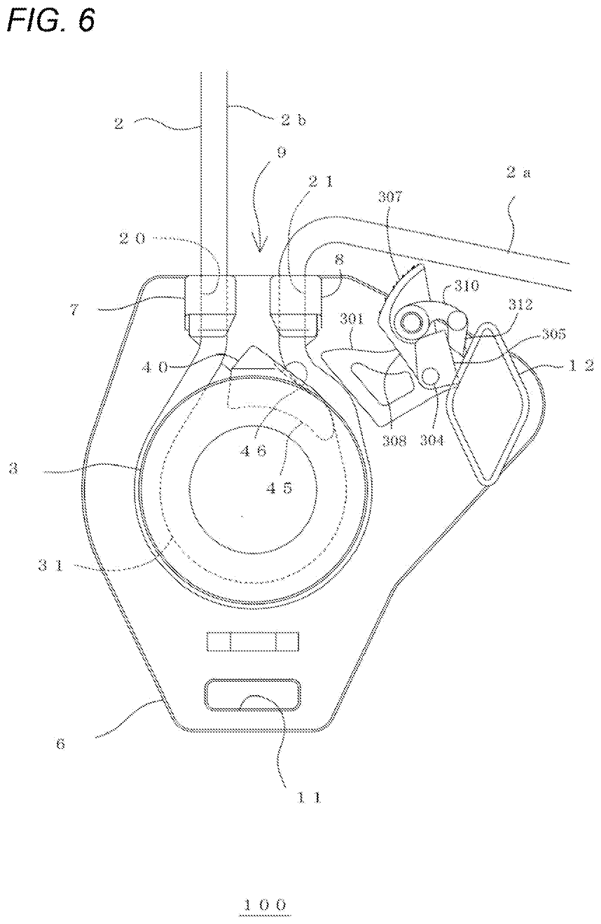

A separation portion 40 separates the inlet side and the outlet side of the rope 2 wound around the pulley 3 into left and right, and has a right side in FIG. 3 extending obliquely downward in a nose shape to form a rope contact portion 45 that is loosely inserted into an H-shaped groove 31 (see FIG. 6) of the pulley 3. The rope contact portion 45 is formed with a rope groove 46 having an arc-shaped cross portion on an outer side surface. The pulley cover 14 is formed with an opening 140 in a side surface of an upper right portion in FIG. 2, so that the cam 308 and the releasing operation member 310 would not interfere with the pulley cover 14 even during pivot.

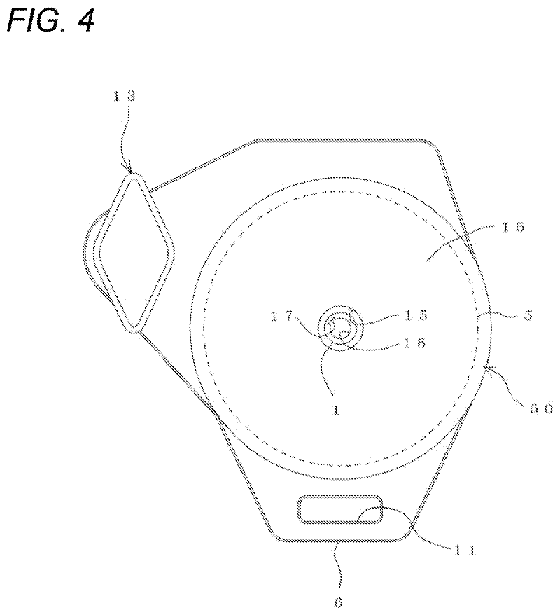

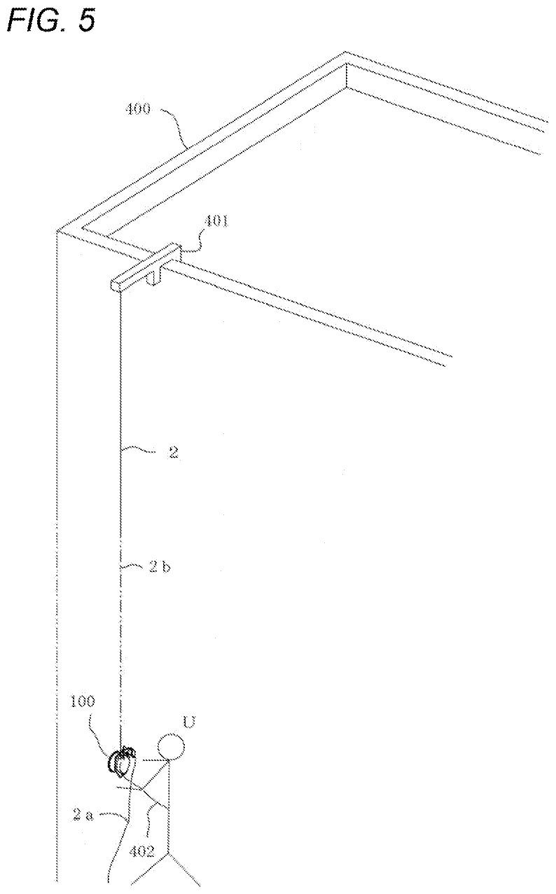

When describing a method for filling a rope using the ascender as in FIGS. 1 to 4 for climbing along an outer wall of a building, as illustrated in FIG. 5, one end side of the rope 2 is fixed to a parapet 401 on a roof of a building 400 to ensure a fulcrum, and the other end side is dropped to the ground.

A user U wearing a harness (not illustrated) on the ground first operates the operation protrusion 311 of the prevention unit 300 with a finger to pivot the cam 308 and the releasing operation member 310 in parallel, and engages the engagement portion 312 with the outer side of the bent portion 305 as illustrated in FIG. 6. The pulley cover 14 is opened to insert the other end side of the rope 2 into a rope insertion groove 20 of the inlet portion 7. The rope 2 passes through a left side of the separation portion 40, and is loosely wound around the pulley 3, fitted into the rope groove 46 of the rope contact portion 45 of the separation portion 40, inserted into a rope insertion groove 21 of the outlet portion 8 (see FIG. 6), and then wound around and hooked on the hook portions 12 and 13.

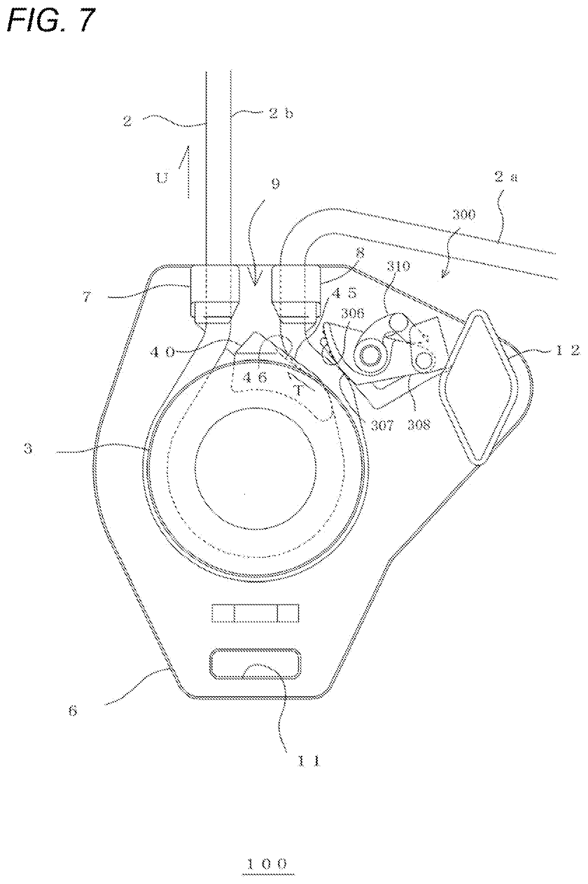

Then the pulley cover 14 is closed, and the operation protrusion 311 of the releasing operation member 310 is operated with a finger to disengage the engagement portion 312 and pivot the cam 308 and the releasing operation member 310 in parallel, so that the cam 308 approaches the rope 2 and the finger is released. The outer peripheral portion 307 of the cam 308 is biased to pivot toward the rope by a spiral spring, and the rope 2 is pressed against the rope contact portion 45 (see FIG. 7). When a force in a direction (see an arrow T in FIG. 7) from a vicinity of a rope outlet of the pulley 3 (a vicinity of an inlet of the rope groove 46) toward the outlet portion 8 is applied to the rope 2, a clockwise external force is applied to the cam 308, and the cam 308 easily pivots clockwise since the outer peripheral portion 307 is separated from the rope 2 fitted in the rope groove 46, so that an outlet-side rope 2a is allowed to move to outside from the outlet portion 8. On the other hand, when a force in a direction (see an arrow U in FIG. 7) of pulling the rope 2 upward from the inlet portion 7 is applied to the rope 2, a counterclockwise external force is applied to the cam 308, and the outer peripheral portion 307 of the cam 308 bites into the rope 2 to prevent movement since the outer peripheral portion 307 approaches the rope 2 fitted in the rope groove 46 (the rope 2 is sandwiched between the cam 308 and the rope contact portion 45).

After the harness worn on the user U is coupled with the attachment hole 11 of the ascender 100 by a sling 402 (or a carabiner or the like (not illustrated)), to start climbing by pulling the rope 2, the user U detaches the outlet-side rope 2a from the hook portions 12 and 13, couples the drive shaft 602, which is attached to the chuck 601 of the rechargeable power screwdriver 600, to the input shaft 1 as illustrated in FIGS. 8A and 8B, and operates and rotates the rechargeable power screwdriver 600 forward, so that the pulley 3 rotates forward after being decelerated by the reduction drive 5. At this time, the prevention unit 300 allows the movement of the rope 2, and thus the rope 2 is smoothly pulled, the ascender 100 rises, and the user U hung down from the sling 402 can climb along the outer wall of the building 400.

When it is desired to stop pulling the rope 2 and stop climbing, the operation of the input shaft 1 by the rechargeable power screwdriver 600 is stopped. At this time, a tension is generated in an inlet-side rope 2b to which the load of the user U is applied, and a reverse rotational force is generated in the pulley 3, the reduction drive 5, the input shaft 1, the drive shaft 602, and the rechargeable power screwdriver 600.

The outlet-side rope 2a fitted in the rope groove 46 of the rope contact portion 45 is pulled in the direction of the pulley 3 and slightly pulled back, a counterclockwise external force is applied to the cam 308, and the cam 308 bites into the rope 2 to prevent movement since the outer peripheral portion 307 approaches the rope 2. Accordingly, the rope 2 stops moving.

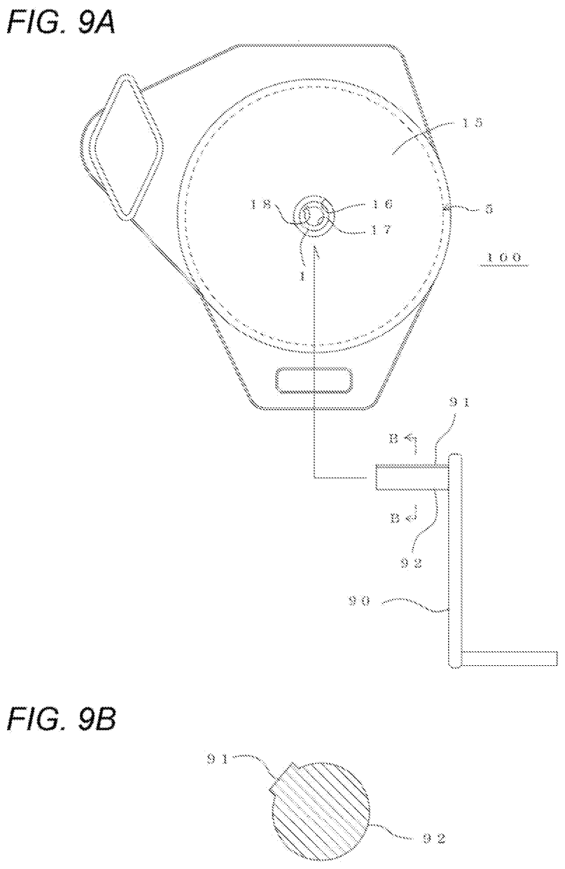

When it is desired to descend in a state where the inlet-side rope 2b is pulled upward in FIG. 7, the outlet-side rope 2a is wound around and hooked on the hook portions 12 and 13. As illustrated in FIGS. 9A and 9B, a manual rotary tool 90 including a drive shaft 92 having a key portion 91 is coupled to the input shaft 1 and rotated forward, and the biting of the cam 308 into the rope 2 is loosened. The operation protrusion 311 of the prevention unit 300 is operated with a finger to pivot the cam 308 and the releasing operation member 310 in parallel. As illustrated in FIG. 6, the engagement portion 312 is engaged with the outer side of the bent portion 305. Then, when a gripping force for gripping the outlet-side rope 2a from the hook portions 12 and 13 is weakened, the pulley 3 and the reduction drive 5 are reversely rotated by a pulling force of the inlet-side rope 2b due to the downward load applied to the ascender 100, and the outlet-side rope 2a is pulled back to the inlet side and the user U descends. At this time, slow operation can be performed by the differential reduction drive 5.

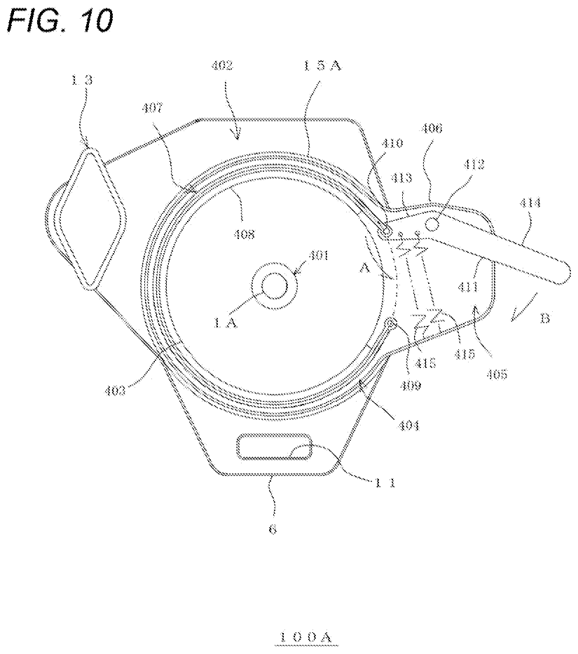

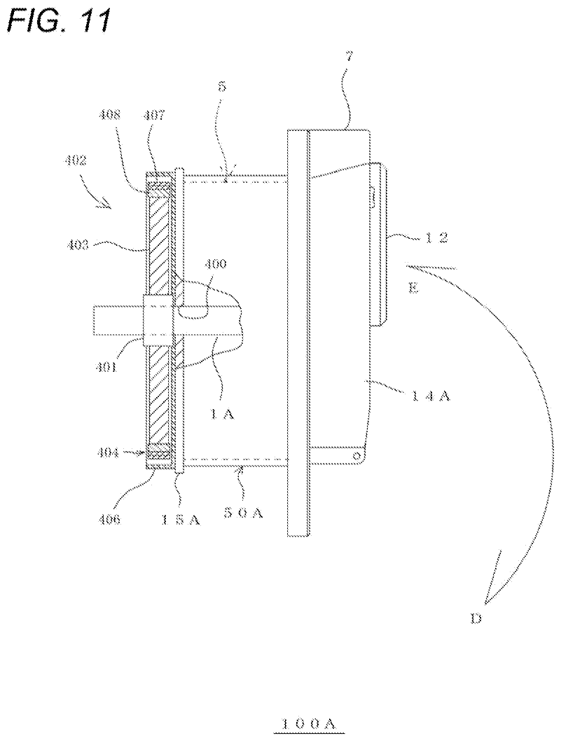

FIG. 10 is a back view of a power ascender, and FIG. 11 is a side view of FIG. 10 with a part broken and omitted.

In a power ascender 100A in FIGS. 10 and 11, an input shaft 1A of a reduction drive 50A extends to outside through a shaft hole 400 bored in a sealing case 15A. A one-way clutch portion 401 is undetachably attached and fixed to an outer periphery of the input shaft 1A. The one-way clutch portion 401 allows the input shaft 1A to rotate forward and prevents the input shaft 1A from rotating reversely. The one-way clutch portion 401 may be detachably fixed and attached to the input shaft 1A.

A rotation restricting and releasing portion 402 is provided on a back surface side of the sealing case 15A. The rotation restricting and releasing portion restricts the rotation of the one-way clutch portion 401 about an axis of the input shaft 1A and releases the rotation restriction. When the rotation restricting and releasing portion 402 restricts the rotation of the one-way clutch portion 401 about the axis of the input shaft 1A, the one-way clutch portion 401 exhibits an original one-way clutch function to allow the forward rotation of the input shaft 1A and prevent the reverse rotation. On the other hand, when the rotation restriction of the one-way clutch portion 401 about the axis of the input shaft 1A is released and an external force for reverse rotation is applied to the one-way clutch portion 401 through the input shaft 1A, the one-way clutch portion 401 rotates about the axis of the input shaft 1A together with the input shaft 1A, so that the original function of the one-way clutch portion 401 cannot be exhibited and the reverse rotation of the input shaft 1A is not prevented.

The rotation restricting and releasing portion 402 may be, for example, a brake mechanism that restricts the rotation of the one-way clutch portion 401 about the axis of the input shaft 1A by applying a brake and releases the rotation restriction by releasing the brake. Examples of the brake mechanism include a band brake mechanism, a drum brake mechanism, and an electromagnetic brake mechanism. In the embodiment, a band brake mechanism will be described as an example.

Specifically, the rotation restricting and releasing portion 402 includes a disk-shaped brake drum portion 403 fixed and attached to the one-way clutch portion 401, a brake band portion 404 disposed along an outer periphery of the brake drum portion 403, a pressing and releasing portion 405 that constantly presses and biases the brake band portion 404 against the brake drum portion 403 and releases the pressing in response to a release operation of the rotation restriction, and a tray-shaped brake case 406 that is provided on the back surface side of the sealing case 15A and supports the brake band portion 404 and the pressing and releasing portion 405. The brake case 406 covers and protects outer peripheral sides of the brake drum portion 403 and the brake band portion 404. Although the brake case 406 is open axially outward in FIG. 10, the opening may be covered with a lid.

The brake band portion 404 includes a brake band support plate 407 curved in a partial annular shape (a substantial horseshoe shape) having a central angle of about 300 degrees along the outer periphery of the brake drum portion 403, and a brake band 408 that has a partial annular shape (a substantial horseshoe shape) and is fixed to an inner periphery of the brake band support plate 407. The brake band 408 is made of a friction member such as a rubber member, and presses the brake drum portion 403 to generate a friction force. One end portion (fixed end portion) on a lower right side of the brake band support plate 407 is fixed to the brake case 406 via a pin 409, and the other end portion on an upper right side is fixed to a base portion of a lever, which will be described later, of the pressing and releasing portion 405 via a pin 410.

The pressing and releasing portion 405 is provided on a right side of the brake case 406 in FIG. 10. A lever 411 of the pressing and releasing portion 405 is formed in a V shape as a whole, and a corner portion bent in the V shape is pivotally supported by a shaft 412 attached to the brake case 406. The lever 411 includes a base portion 413 extending short in a direction of approaching the brake drum portion 403 from the shaft 412, and an operation portion 414 extending long in a direction away from the brake drum portion 403. The operation portion 414 is used to release the rotation restriction. The pin 410 is implanted in the base portion 413, and one end portion (free end portion) of the brake band support plate 407 on the upper right side in FIG. 10 is fixed to the pin 410.

When the lever 411 pivots counterclockwise in FIG. 10 (arrow A), the pin 410 moves rightward, the free end portion of the brake band support plate 407 is pulled rightward, the brake band portion 404 is wound around the brake drum portion 403, the brake band 408 is pressed against an outer periphery of the brake drum portion 404, and a friction brake is applied. Accordingly, the rotation of the one-way clutch portion 401 about the axis of the input shaft 1A is restricted.

On the other hand, when the lever 411 pivots clockwise in FIG. 10 (arrow B), the pin 410 moves leftward, the free end portion of the brake band support plate 407 returns leftward, the winding of the brake band portion 404 is loosened, the brake band 408 is separated from the outer periphery of the brake drum portion 403, the pressing is released, and the friction brake is released. Accordingly, the rotation restriction of the one-way clutch portion 401 about the axis of the input shaft 1A is released.

Two sets of tension springs 415, which constantly bias the lever 411 counterclockwise, are interposed between a portion of the base portion 413 of the lever 411 that is in a vicinity of the brake drum portion 403 when viewed from the shaft 412 and an outer peripheral edge portion of the brake case 406. When no external force is applied to the operation portion 414, the lever 411 pivots counterclockwise by the tension springs 415, the brake band 408 is pressed against and biased to the outer periphery of the brake drum portion 403, and the rotation of the one-way clutch portion 401 is restricted.

In this state, when the operation portion 414 is operated counterclockwise by the user in FIG. 10 (pressing release operation=rotation restriction release operation of the one-way clutch portion 401), the lever 411 pivots clockwise, the brake band 408 separates from the outer periphery of the brake drum portion 403, the pressing is released, the friction brake is released, and the rotation restriction of the one-way clutch portion 401 is released.

Other components of the ascender 100A are the same or similar to those of the ascender 100 described in FIGS. 1 to 9B, but a prevention unit 300 is omitted. Further, an outlet side of a separation portion 40D extends into an H-groove 31 of a pulley 3 in a nose shape such that a rope 2 biting into the H-groove 31 can be drawn out from the H-groove 31 (see FIG. 12). A pulley cover 14A has no opening 140.

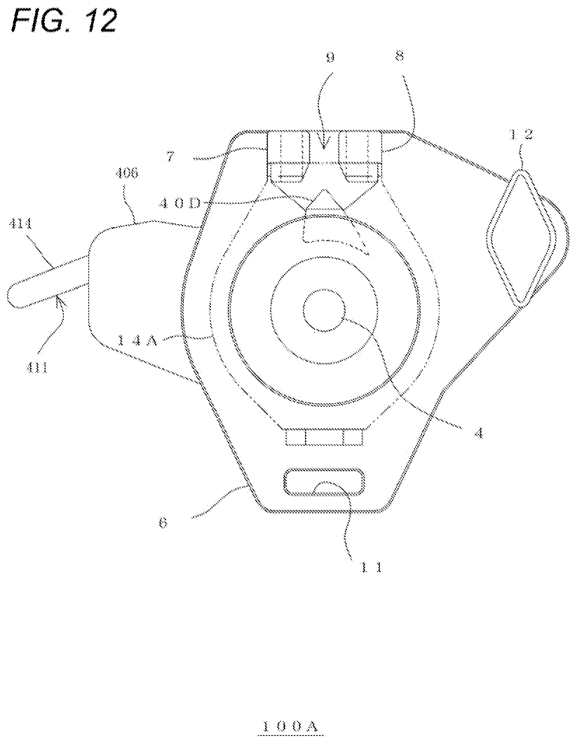

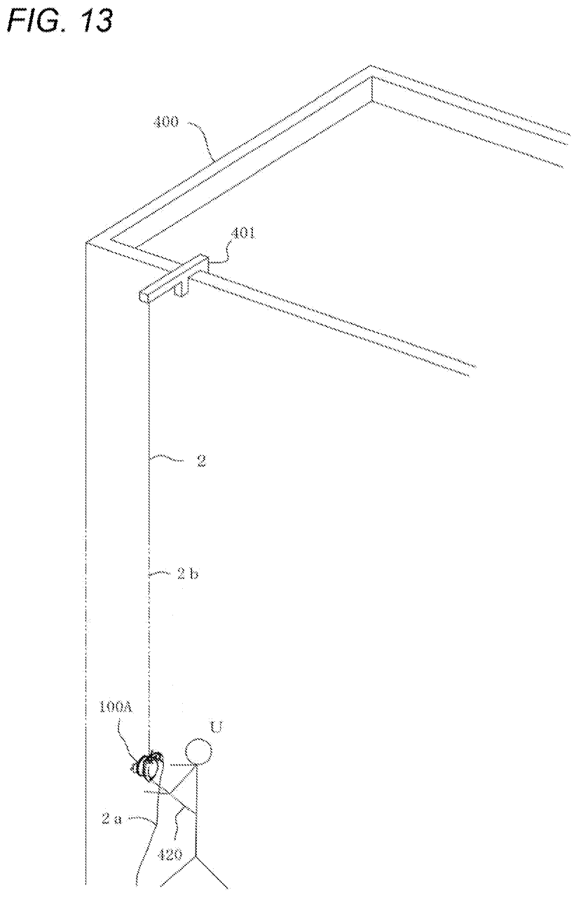

Next, a method for using the ascender described above will be described with reference to FIGS. 13 to 15.

When describing a method for filling a rope used for ascending along an outer wall of a building, as illustrated in FIG. 13, one end side of the rope 2 is fixed to a parapet 401 on a roof of a building 400 to ensure a fulcrum, and the other end side is dropped to the ground.

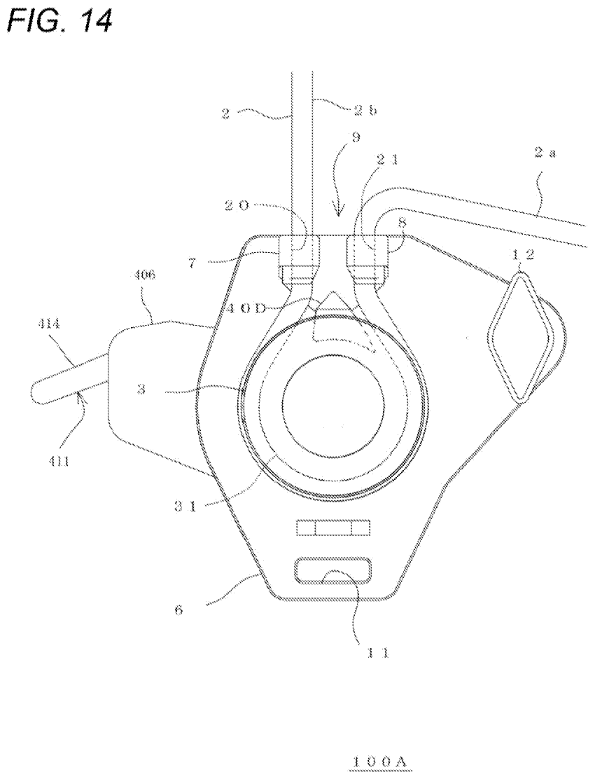

A user U wearing a harness (not illustrated) on the ground first opens the pulley cover 14A (see an arrow D in FIG. 11), and inserts one end side of the rope 2 into a rope insertion groove 20 of an inlet portion 7. The rope 2 passes through a left side of the separation portion 40D and is loosely wound around the pulley 3, passes through a right side of the separation portion 40D and is inserted into a rope insertion groove 21 of an outlet portion 8 (see FIG. 14), and is then wound around and hooked on hook portions 12 and 13. Then, the pulley cover 14A is closed (see an arrow E in FIG. 11).

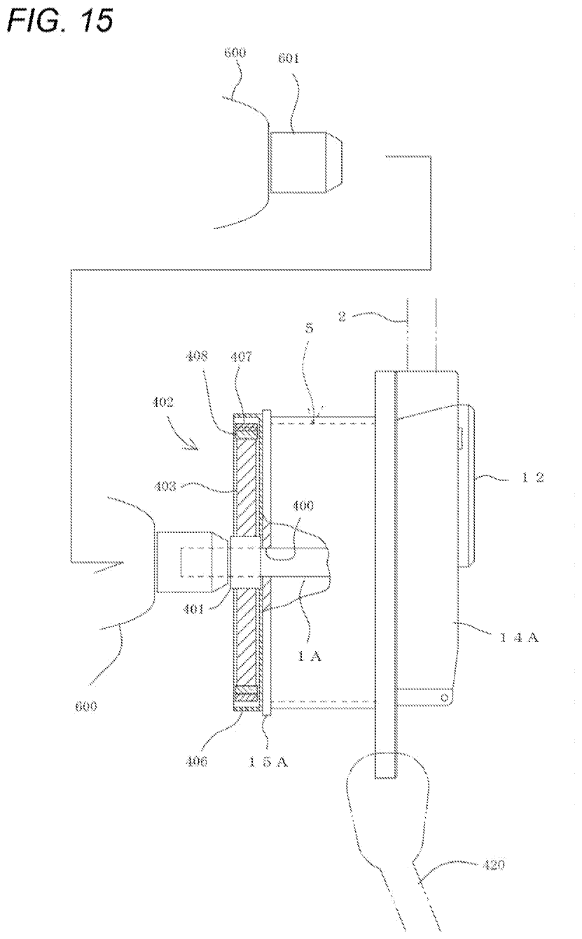

The user U couple the harness worn on the user U with an attachment hole 11 of the ascender 100A via a sling 420 (or a carabiner) (see FIG. 15).

Here, in the ascender 100A, when no external force is applied to the operation portion 414 of the lever 411, the brake band 408 is pressed against the brake drum portion 403 by the tension springs 415 of the pressing and releasing portion 405 of the rotation restricting and releasing portion 402 to generate a friction brake, and the one-way clutch portion 401 is in a rotation restricted state.

To pull the rope 2 and start climbing, an outlet-side rope 2a is detached from the hook portions 12 and 13, and as illustrated in FIG. 15, a chuck 601 that is a drive shaft of a rechargeable power screwdriver 600 is coupled to the input shaft 1A.

In this state, when the rechargeable power screwdriver 600 is operated and driven to rotate forward, the one-way clutch portion 401 whose rotation about the axis of the input shaft 1A is restricted allows the forward rotation of the input shaft 1A, and thus the input shaft 1A rotates forward. The forward rotational speed of the input shaft 1A is reduced by the reduction drive 50A and the pulley 3 is rotated forward, so that the rope 2 is pulled from an inlet side to an outlet side. As a result, the ascender 100A rises, and the user U can be lifted by the sling 420 (or a carabiner) along the outer wall of the building.

When it is desired to stop pulling the rope 2 and stop climbing, the operation of the rechargeable power screwdriver 600 is stopped and the driving of the input shaft 1A is stopped. At this time, an inlet-side rope 2b to which the weight of the user U is applied is pulled downward and a tension is generated, a pulling force returning from an outlet side to an inlet side of the pulley 3 is applied to the rope 2, and a reverse rotational force is generated in the pulley 3, the reduction drive 50A, and the input shaft 1A.

Here, the one-way clutch portion 401 restricts the reverse rotation of the input shaft 1A and intends to rotate itself, but the one-way clutch function works since the rotation about the axis of the input shaft 1A is restricted by the rotation restricting and releasing portion 402, and rotation of the pulley 3, the reduction drive 50A, the input shaft 1A, and the chuck 601 is stopped. As a result, no reverse rotational force is transmitted to the rechargeable power screwdriver 600, and damage can be prevented.

Subsequently, the outlet-side rope 2a is wound around the hook portions 12 and 13 to restrict the movement of the rope 2, the chuck 601 of the rechargeable power screwdriver 600 is detached from the input shaft 1A, and the coupling between the rechargeable power screwdriver 600 and the input shaft 1A is released.

A tension directed from the outlet side to the inlet side is applied to the rope 2 due to the tension generated in the inlet-side rope 2b to which the weight of the user U is applied, and a reverse rotational force is generated in the pulley 3, the reduction drive 50A, and the input shaft 1A. However, the one-way clutch portion 401 in the rotation restricted state prevents the reverse rotation of the input shaft 1A to prevent the reverse rotation of the pulley 3, and the outlet-side rope 2a is wound around the hook portions 12 and 13. Accordingly, the rope 2 does not move and the pulley 3 does not rotate even when the hand is separated from the inlet-side rope 2b. In this state, the user U can perform a desired task on the outer wall of the building.

Thereafter, when it is desired to climb further upward, the chuck 601 of the rechargeable power screwdriver 600 is coupled to the input shaft 1A as described above. Then, the outlet-side rope 2a is detached from the hook portions 12 and 13. In this state, when the rechargeable power screwdriver 600 is operated to rotate forward, the one-way clutch portion 401 allows the forward rotation of the input shaft 1A, and thus the chuck 601 of the rechargeable power screwdriver 600 rotates forward to rotate the input shaft 1A in the forward direction. The forward rotational speed of the input shaft 1A is reduced by the reduction drive 50A and the pulley 3 is rotated forward, so that the rope 2 is pulled from an inlet side to an outlet side. As a result, the ascender 100A rises, and the user U can be lifted by the sling 420 (or a carabiner) along the outer wall of the building.

On the other hand, when it is desired to descend from a stopped state in a state where the rechargeable power screwdriver 600 is detached from the input shaft 1A of the ascender 100A, the outlet-side rope 2a wound around the hook portions 12 and 13 is detached, and the inlet-side rope 2b is gripped by a right hand to allow the rope 2 wound around the pulley 3 to freely move. Since the weight of the user U is applied to the ascender 100A via the sling 420, a tension is applied to the inlet-side rope 2b, and the pulley 3 intends to rotate reversely. However, the pulley 3 does not rotate reversely and the rope 2 does not move since the one-way clutch portion 401 in the state in which the rotation about the axis of the input shaft 1A is restricted prevents the reverse rotation of the input shaft 1A.

Next, the operation portion 414 of the lever 411 is pushed with a left hand downward and clockwise (arrow B direction) in FIG. 10 against a pulling force of the tension springs 415, so that the rotation restriction of the one-way clutch portion 401 is released. At this time, the base portion 413 of the lever 411 pivots clockwise, the brake band 408 is separated from the outer periphery of the brake drum portion 403, the pressing is released, the friction brake is released, and the rotation restriction of the one-way clutch portion 402 about the axis of the input shaft 1A is released.

As a result, in response to the reverse rotational force applied to the input shaft 1A, the one-way clutch portion 401 rotates reversely together with the input shaft 1A, the pulley 3 rotates reversely, the outlet-side rope 2a moves and returns to the inlet side, so that the user can descend together with the ascender 100A. At this time, slow operation can be performed by the differential reduction drive 50A.

When it is desired to stop descending, the pushing down of the operation portion 414 of the lever 411 may be released and the outlet-side rope 2a may be wound around the hook portions 12 and 13. The lever 411 is biased by the tension springs 415 to pivot counterclockwise in FIG. 10, the brake band 408 is pressed against the outer periphery of the brake drum portion 403, a friction brake is applied, and the rotation of the one-way clutch portion 401 about the input shaft 1A is restricted. Accordingly, the descending stops since the one-way clutch portion 401 limits the reverse rotation of the input shaft 1A again and the reverse rotation of the pulley 3 is prevented.

According to the ascender in FIG. 10, when the input shaft 1A is driven to rotate forward by the rechargeable power screwdriver 600, which is an example of a rotary power tool, in a state in which the rotation of the one-way clutch portion 401 externally fitted to the input shaft 1A is restricted by the rotation restricting and releasing portion 402, the one-way clutch portion 401 does not restrict the rotation of the input shaft, a rotational force of the rechargeable power screwdriver 600 is transmitted to the input shaft 1A, the rotational speed is reduced by the reduction drive 50A, and then the pulley 3 is rotated forward. As a result, the rope 2 can be pulled and moved from the inlet side to the outlet side of the pulley to lift and raise the body of the user.

When it is desired to stop climbing, the operation of the rechargeable power screwdriver 600 is stopped. At this time, a reverse rotational force is generated in the pulley 3, the reduction drive 50A, and the input shaft 1A by the tension generated in the inlet-side rope 2b to which the weight of the user is applied. The one-way clutch portion 401 intends to rotate about the axis of the input shaft 1A in response to the reverse rotational force of the input shaft 1A, but the one-way clutch function works since the rotation about the input shaft is restricted, and reverse rotation of the pulley 3, the reduction drive 50A, and the input shaft 1A is prevented. As a result, no reverse rotational force is transmitted to the rechargeable power screwdriver 600, and damage can be prevented.

When it is desired to descend, the rechargeable power screwdriver 600 is detached from the input shaft 1A, the operation portion 414 of the lever 411 is pushed downward and clockwise in FIG. 10 to perform the release operation, and the rotation restricted state of the one-way clutch portion 401 by the rotation restricting and releasing portion 402 is released. At this time, the one-way clutch portion 401 rotates together with the input shaft 1A by the reverse rotational force transmitted to the input shaft 1A of the reduction drive 50A through the pulley 3 due to the tension generated in the inlet-side rope 2b to which the weight of the user is applied. As a result, the one-way clutch function does not work, the reverse rotation of the input shaft 1A is not prevented, the reverse rotation of the pulley 3 and the reduction drive 50A is possible, and the rope 2 can be moved from the outlet side to the inlet side of the pulley 3 and descending is possible.

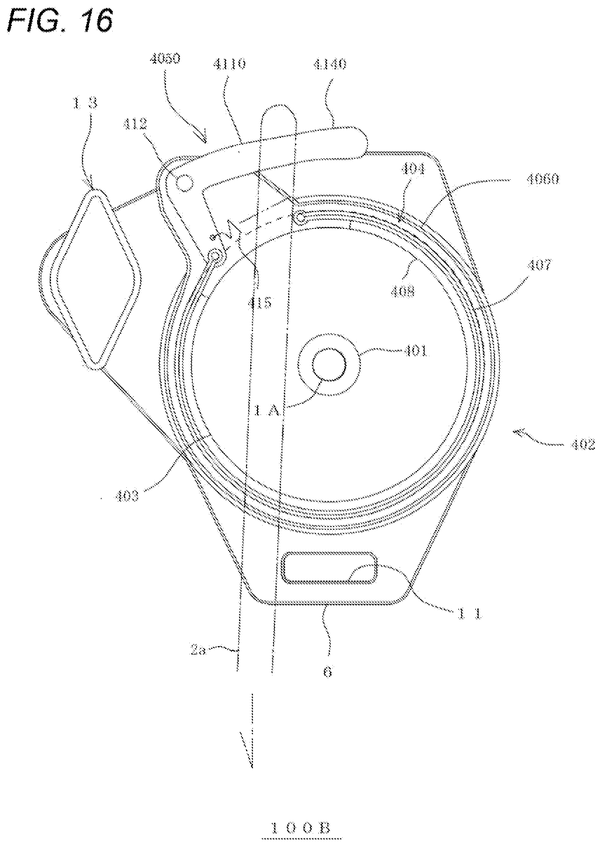

The pressing release operation is performed on the operation portion 414 of the lever 411 by hand in the above-described ascender. Alternatively, as illustrated in FIG. 16, a pressing and releasing portion 4050 may be provided on an upper portion of a brake case 4060, an operation portion 4140 of a lever 4110 that pivots and returns by a tension spring 415 may protrude on a support body 6, the outlet-side rope 2a of the rope 2 may be gripped and hooked on the operation portion 4140 during reverse rotation of the pulley 3, so that the operation portion 4140 may be pushed downward to enable release operation. In the case of the example in FIG. 16, when it is desired to descend, the outlet-side rope 2a of the pulley 3 is held by the left hand and hooked on the operation portion 4140, so that the pressing release operation can be performed by pushing the operation portion 4140 downward, and the inlet-side rope 2b and the outlet-side rope 2a can be gripped by respective hands and descending is possible.

The ascender does not include the prevention unit 300 in an ascender 100 in the related art described in FIGS. 1 to 9B. Alternatively, the ascender may include the prevention unit 300 described in FIGS. 1 to 9B on a front surface of the support body 6 (the separation portion and the pulley cover are denoted by reference numerals 40 and 14). When the prevention unit 300 is provided to stop climbing, a cam 308 of the prevention unit 300 can bite into the rope 2 to prevent the movement of the rope 2 after the operation of the rotary power tool is stopped and detached from the input shaft. When the operation of the rotary power tool is stopped, even when the one-way clutch portion 401 fails before the rotary power tool is detached from the input shaft 1A, the cam 308 of the prevention unit 300 bites into the rope 2 to prevent the movement of the rope 2, and unintentional descending can be prevented.

Here, when the rotary power tool is switchable between forward rotation and reverse rotation and is driven by mistake to rotate reversely after being coupled to the input shaft and driven to rotate forward for climbing, the input shaft rotates reversely together with the one-way clutch portion and the brake drum portion overcoming the frictional force of the brake band portion, and the pulley rotates reversely. At this time, for example, when the ascender includes the prevention unit 300, a surface of the rope may be torn by teeth of the cam.

When the frictional force of the brake band portion is large and the rotary power tool is driven by mistake to rotate reversely, the input shaft does not rotate, the rotary power tool rotates by a reaction force, a hand may be hurt, and the rotary power tool may hit the user in the face.

As a countermeasure against this, a rotary power tool drive shaft (tip tool, and hereinafter, simply referred to as “drive shaft”) detachably attached to the rotary power tool may be provided to drive the input shaft of the ascender, a second one-way clutch portion may be attached to the drive shaft, and the input shaft may be driven through the second one-way clutch portion.

Specifically, as illustrated in FIG. 17, a drive shaft 610 detachable to the chuck 601 of the rechargeable power screwdriver 600 is prepared. The drive shaft 610 has a stepped structure in which a small-diameter portion 611 and a large-diameter portion 612 are integrated in an axial direction, and the small-diameter portion 611 is detachably attached to the chuck 601. In the large-diameter portion 612, a second one-way clutch portion 613 having a tubular shape is attached to a hollow interior. The second one-way clutch portion 613 can be detachably fitted to an outer periphery of a tip portion 1b of the input shaft 1A of the ascender. When the second one-way clutch portion 613 is fitted to the tip portion 1b, the drive shaft 610 attached to the chuck 601 of the rechargeable power screwdriver 600 can be coupled to the input shaft 1A. The second one-way clutch portion 613 has a function of transmitting a forward rotational force directly to the input shaft 1A to drive the input shaft 1A to rotate forward when the rechargeable power screwdriver 600 rotates forward and the drive shaft 610 rotates forward, and preventing the reverse rotational force from being transmitted to the input shaft 1A when the rechargeable power screwdriver 600 rotates reversely and the drive shaft 610 rotates reversely. Accordingly, even when the rechargeable power screwdriver 600 rotates reversely by mistake, the input shaft 1A, the reduction drive 50A, and the pulley 3 can be prevented from rotating reversely by simply idling the drive shaft 610.

Accordingly, the pulley 3 does not rotate reversely even when the rechargeable power screwdriver 600 is driven by mistake to rotate reversely after being coupled to the input shaft and driven to rotate forward for climbing. Accordingly, for example, even when the ascender includes the prevention unit 300, the surface of the rope would not be torn by the teeth of the cam. Further, the rotary power tool itself does not rotate, and thus the hand would not be hurt or the rotary power tool would not hit the user in the face.

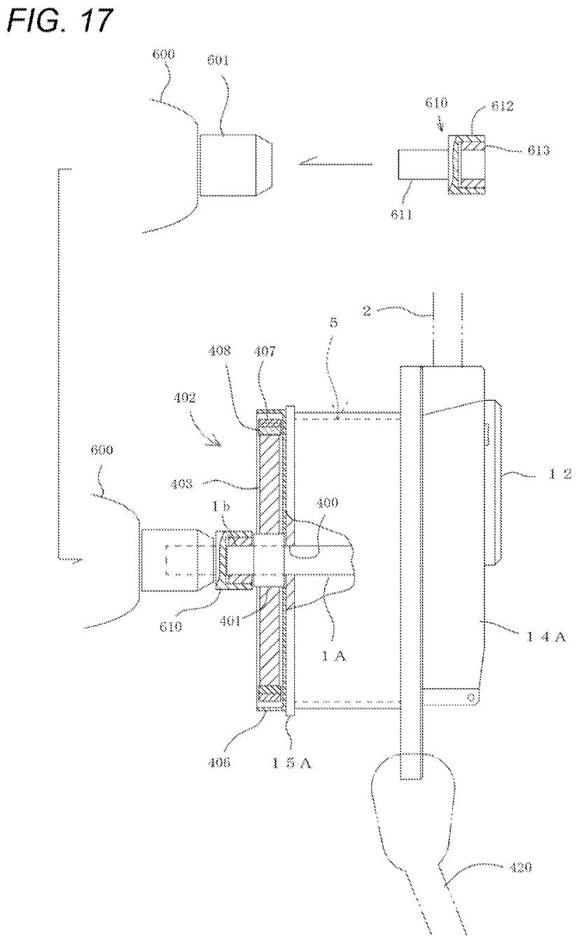

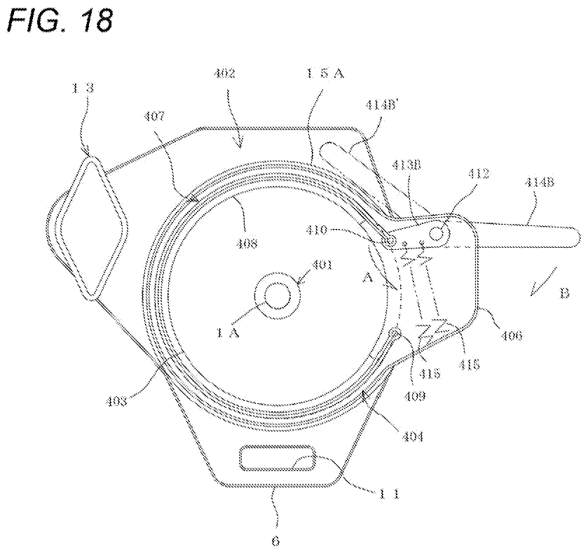

In the above-described embodiment, the rotation restriction release operation of the one-way clutch portion 401 is performed by the operation portion 414 of the lever 411 having a V shape. Alternatively, as illustrated in FIG. 18, instead of the lever, a pivot plate 413B pivotally supported by the shaft 412 on an inner side of the plate case 406 and an operation portion 414B pivotally supported by the shaft 412 on an outer side of the brake case 406 may be provided. One end portion (free end portion) of the brake band support plate 407 on a right upper side in FIG. 18 may be fixed to the pivot plate 413B via the pin 410, and one set of tension springs 415 may be interposed between the pivot plate 413B and a peripheral edge portion of the brake case 406.

In the case of FIG. 18, when no external force is applied to the operation portion 414B, the pivot plate 413B pivots counterclockwise (arrow A) by the tension springs 415, the brake band 408 is pressed against and biased to the outer periphery of the brake drum portion 403, and the rotation of the one-way clutch portion 401 is restricted.

In this state, when the operation portion 414B is operated counterclockwise by the user in FIG. 18 (pressing release operation=rotation restriction release operation of the one-way clutch portion 401), the pivot plate 413B pivots clockwise, the brake band 408 separates from the outer periphery of the brake drum portion 403, the pressing is released, the friction brake is released, and the rotation restriction of the one-way clutch portion 401 is released.

When not in use, the operation portion 414B may be retractable from a position indicated by a solid line in FIG. 18 to a position indicated by a long-dashed double short-dashed line (reference numeral 414B′) along an outer periphery of the case 15A by a spring (not illustrated) attached to the shaft 412. In this case, when the operation portion 414B pivots to the position indicated by the solid line in FIG. 18 during use, the pivot plate 413B may not pivot, and the pivot plate 413B may pivot in conjunction with a downward operation from the position indicated by the solid line in FIG. 18.

### First Embodiment

Here, when the drive shaft 610 in FIG. 18 is attached to or detached from the input shaft 1A, the second one-way clutch portion 613 directly comes into contact with the input shaft 1A. Accordingly, the second one-way clutch portion 613 is likely to be damaged.

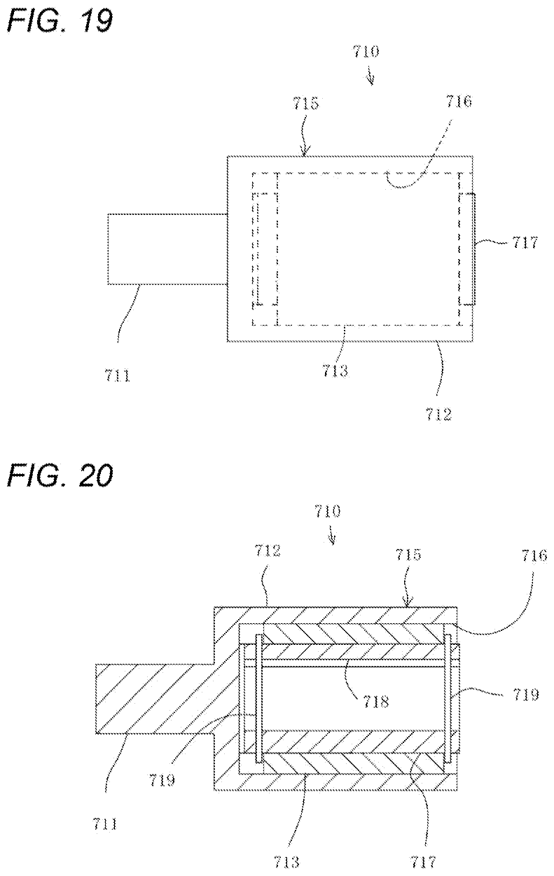

FIGS. 19 and 20 show a rotary power tool drive shaft (tip tool, hereinafter, referred to as a “drive shaft”) according to an embodiment of the present disclosure.

A drive shaft 710 in FIGS. 19 and 20 is an improvement of the drive shaft 610 in FIG. 17. The drive shaft 710 in FIG. 19 includes a stepped outer shaft portion 715 in which a small-diameter portion 711 and a large-diameter portion 712 are integrated in the axial direction, the tubular second one-way clutch portion 713 fixed to a hollow interior 716 of the large-diameter portion 712 by press fitting, and a tubular inner shaft portion 717 pivotally supported in the second one-way clutch portion 713 to be rotatable in one direction. The small-diameter portion 711 can be detachably attached to the chuck 601 of the power screwdriver 600 of the rotary power tool. A key groove portion 718 extending in the axial direction is formed in one position in the circumferential direction on an inner surface side of the inner shaft portion 717.

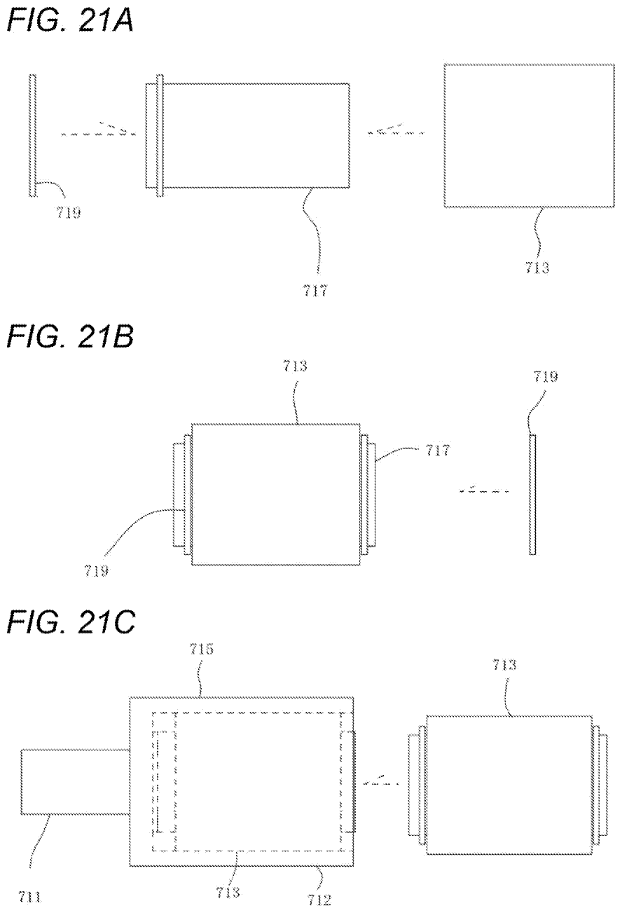

FIGS. 21A, 21B, and 21C are assembly views of the drive shaft 710, in which the inner shaft portion 717 is inserted into the second one-way clutch portion 713, and snap rings 719 are fitted to the inner shaft portion 717 with both sides of the second one-way clutch portion 713 sandwiched therebetween, so that the second one-way clutch portion 713 is prevented from moving in the axial direction (FIGS. 21A and 21B). The rotation of the inner shaft portion 717 in one direction is prevented relative to the second one-way clutch portion 713, but the rotation in the other direction is not prevented. Here, the prevented direction is the counterclockwise direction in which the input shaft 1A is rotated reversely when the large-diameter portion 712 is viewed from the small-diameter portion 711, and the not-prevented direction is the clockwise direction in which the input shaft 1A is rotated forward.

The second one-way clutch portion 713 including the inner shaft portion 717 is fixed to the hollow interior 716 of the large-diameter portion 712 of the outer shaft portion 715 in the axial direction by press fitting, and is thus non-rotatably attached to the outer shaft portion 715 (FIG. 21C).

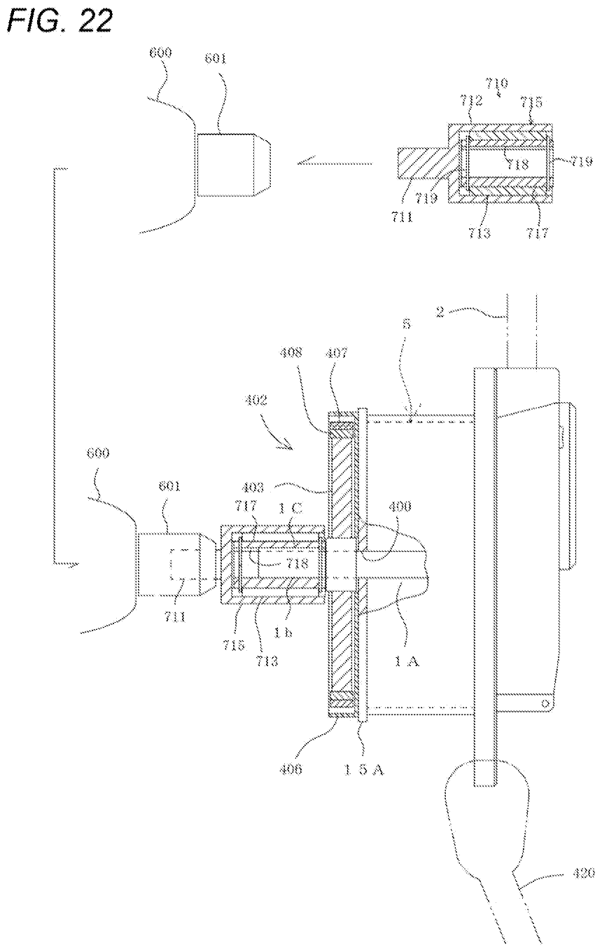

When the drive shaft 710 is used, as illustrated in FIG. 22, the ascender includes, in the tip portion 1b of the input shaft 1A, a key portion 1C corresponding to the key groove portion 718 of the inner shaft portion 717.

Next, a method for using the drive shaft 710 will be described with reference to FIG. 22.

Before starting climbing, the small-diameter portion 711 of the drive shaft 710 is attached to the chuck 601 of the rechargeable power screwdriver 600. Then, by aligning the key portion 1C with the key groove portion 718 and inserting and fitting the tip portion 1b of the input shaft 1A into the inner shaft portion 717, the drive shaft 710 attached to the chuck 601 of the rechargeable power screwdriver 600 is coupled to the input shaft 1A.

At this time, the input shaft 1A does not directly come into contact with the second one-way clutch portion 713, and thus the second one-way clutch portion 713 can be prevented from damage.

When it is desired to start climbing, the rechargeable power screwdriver 600 is rotated forward. At this time, the outer shaft portion 715 of the drive shaft 710 and the second one-way clutch portion 713 integrally rotate forward, and the inner shaft portion 717 whose reverse rotation relative to the second one-way clutch portion 713 is prevented also rotates forward. Accordingly, the input shaft 1A is driven to rotate forward, the pulley 3 rotates forward via the reduction drive, and the user can rise along the inlet-side rope 2b.

When the rechargeable power screwdriver 600 is rotated reversely during climbing by mistake and the drive shaft 710 is reversely rotated, the outer shaft portion 715 of the drive shaft 710 and the second one-way clutch portion 713 are integrally rotated reversely. However, the forward rotation of the inner shaft portion 717 relative to the second one-way clutch portion 713 is not prevented, and thus the input shaft 1A and the inner shaft portion 717 remain stopped, and only the second one-way clutch portion 713 and the outer shaft portion 715 idle. As a result, the second one-way clutch portion 713 has a function of preventing a reverse rotational force from being transmitted to the input shaft 1A. Accordingly, even when the rechargeable power screwdriver 600 rotates reversely by mistake, the input shaft 1A, the reduction drive 50A, and the pulley 3 can be prevented from rotating reversely.

According to this embodiment, the input shaft 1A of the ascender is driven by the rotary power tool drive shaft 710 that is detachably attached to the rotary power tool, the second one-way clutch portion 713 is attached to the drive shaft 710, and the input shaft 1A is driven via the second one-way clutch portion 713. The second one-way clutch portion 713 has a function of transmitting the forward rotational force directly to the input shaft 1A through the inner shaft portion 717 to rotate the input shaft 1A forward when the rechargeable power screwdriver 600 rotates forward and the outer shaft portion 715 of the drive shaft 710 rotates forward, and preventing the reverse rotational force from being transmitted to the input shaft 1A when the rechargeable power screwdriver 600 rotates backward and the outer shaft portion 715 of the drive shaft 710 rotates backward. Accordingly, even when the rechargeable power screwdriver 600 rotates reversely by mistake, the input shaft 1A, the reduction drive 50A, and the pulley 3 can be prevented from rotating reversely by simply idling the outer shaft portion 715 of the drive shaft 710. Accordingly, the pulley 3 does not rotate reversely even when the rechargeable power screwdriver 600 is driven by mistake to rotate reversely after being coupled to the input shaft 1A and driven to rotate forward for climbing. Accordingly, for example, even when the ascender includes the prevention unit 300, the surface of the rope would not be torn by the teeth of the cam. In addition, the rechargeable power screwdriver does not rotate due to a reaction force, and thus the hand would not be hurt and the rechargeable power screwdriver would not hit the user in the face.

Further, when the drive shaft 710 is attached to or detached from the input shaft 1A of the ascender, the second one-way clutch portion 713 does not directly come into contact with the input shaft 1A. Accordingly, the second one-way clutch portion 713 can be prevented from damage.

In the above embodiment, the inner shaft portion has a tubular shape, and the key groove portion is provided on an inner diameter side. Alternatively, the key portion may be provided on the inner diameter side. Further, the inner shaft portion may have a rod shape instead of a tubular shape.

### INDUSTRIAL APPLICABILITY

The present disclosure can be applied to an ascender or a rope traction device for pulling a rope and raising a person.

What is claimed is:

1. A method for climbing and descending using an ascender, the ascender including a differential reduction drive that includes an input shaft configured to be driven by a rotary power tool and an output shaft coupled to a pulley allowing a rope to be wound, reduces a forward rotational speed applied to the input shaft, and transmits the reduced forward rotational speed to the output shaft,
the method comprising:
driving the input shaft by the power tool and rotating the pulley forward, in a state in which one end side of the rope is located in a high position to ensure a fulcrum, the rope is wound from an inlet side to an outlet side of the pulley of the ascender, a weight of a user is supported by the ascender, and the rotary power tool is coupled to the input shaft, to move the rope from the inlet side to the outlet side of the pulley and to ascend the user; and
rotating the pulley reversely to descend the user in a state in which the rotary power tool is detached from the input shaft,
wherein the input shaft of the ascender is provided with a one-way clutch portion that allows a forward rotation and prevents a reverse rotation,
wherein the forward rotation of the pulley is performed by restricting rotation of the one-way clutch portion about the input shaft and driving the input shaft to rotate forward in a climbing direction by the rotary power tool, and
wherein the reverse rotation of the pulley is performed by releasing the rotation restriction of the one-way clutch portion about the input shaft and allowing the pulley and the reduction drive to rotate reversely by a tension generated in an inlet-side rope to which the weight of the user is applied.

2. The method according to claim 1, wherein
a drive shaft attached to the rotary power tool is coupled to the input shaft to drive the input shaft, and
the drive shaft is provided with a second one-way clutch portion that transmits a forward rotational force to the input shaft and does not transmit a reverse rotational force.

3. The method according to claim 1, wherein
rotation of the one-way clutch portion about the input shaft is restricted by being applied with a brake, and
rotation restriction about the input shaft is released by releasing the brake.

4. An ascender comprising:
a differential reduction drive that includes an input shaft configured to be driven by a rotary power tool and an output shaft coupled to a pulley allowing a rope to be wound around, reduces a forward rotational speed of the input shaft, and transmits the reduced forward rotational speed to the output shaft;
a one-way clutch portion detachably or undetachably attached to the input shaft, allowing forward rotation of the input shaft, and preventing reverse rotation; and
a rotation restricting and releasing portion configured to restrict and release rotation of the one-way clutch portion about an axis of the input shaft.

5. The ascender according to claim 4, wherein
a drive shaft attached to the rotary power tool is coupled to the input shaft to drive the input shaft, and
the drive shaft is provided with a second one-way clutch portion that transmits a forward rotational force to the input shaft and does not transmit a reverse rotational force.

6. The ascender according to claim 4, wherein
the rotation restricting and releasing portion includes a brake mechanism that restricts the rotation of the one-way clutch portion by applying a brake and releases the rotation restriction by releasing the brake.

7. The ascender according to claim 6, wherein
the brake mechanism includes:
a brake drum portion fixed to the one-way clutch portion;
a brake band portion provided along an outer periphery of the brake drum portion; and
a pressing and releasing portion that constantly presses and biases the brake band portion toward the brake drum portion and releases the pressing in response to a pressing release operation.

8. The ascender according to claim 7, wherein
the pressing and releasing portion includes an operation portion by which a user performs the pressing release operation.

9. The ascender according to claim 7, wherein
the pressing and releasing portion includes an operation portion allowing the pressing release operation by gripping and hooking an outlet-side rope of the pulley and pushing the outlet-side rope downward.

10. The ascender according to claim 4, further comprising:
a hook portion allowing the rope wound around the pulley to be hooked, or
an attachment portion allowing a rope other than the rope wound around the pulley or a carabiner to be attached.

11. The ascender according to claim 4, further comprising:
a prevention unit configured to prevent an inlet side of the rope from being drawn out to outside, wherein
the prevention unit includes:
a cam configured to bite into the rope to prevent movement when the rope is moved in a direction of being drawn out from an inlet portion to the outside, and to allow the movement by being separated from the rope when the rope is moved in an opposite direction;
a biasing unit configured to bias the cam in a direction of biting into the rope; and
a releasing unit configured to release the restriction by separating the cam from the rope.

12. A drive shaft for rotary power tool configured to be connectable to an input shaft of an ascender, the ascender including: a differential reduction drive that includes an input shaft configured to be driven by a rotary power tool and an output shaft coupled to a pulley allowing a rope to be wound; a one-way clutch portion detachably or undetachably attached to the input shaft, allowing forward rotation of the input shaft, and preventing reverse rotation; and a rotation restricting and releasing portion configured to restrict and release rotation of the one-way clutch portion about an axis of the input shaft, the drive shaft for rotary power tool comprising:
an outer shaft portion configured to be attached to the rotary power tool;
a second one-way clutch portion fixed to a hollow interior at a tip side of the outer shaft portion and having a tubular shape;
an inner shaft portion that is rotatably supported in an inner side of the second one-way clutch portion such that a rotation of the inner shaft portion in one direction is allowed and a rotation of the inner shaft portion in the other direction is prevented,
wherein the inner shaft portion is formed to be connectable to the input shaft of the ascender.

13. The drive shaft for rotary power tool according to claim 12,
wherein the inner shaft portion has a tubular shape and is provided with a key groove portion or key portion on an inner surface side.
